(19) United States
(12) Patent Application Publication
(10) Pub. No.: US 2003/0192818 A1
(43) Pub. Date: Oct. 16, 2003

(54) Filter plate and frame and method of making

(76) Inventor: Richard Timperio, Highland, NY (US)

Correspondence Address: JACOBSON HOLMAN PLLC, 400 SEVENTH STREET N.W., SUITE 600, WASHINGTON, DC, 20004, US

(21) Appl. No.: 10/120,381

(22) Filed: Apr. 12, 2002

(51) Int. Cl. B01D 25/164; B23P 15/16

(52) U.S. Cl. 210/231; 29/896.62

(57) ABSTRACT

A wrought metal single piece filter outlet plate or inlet frame, which is weld free in the liquid contact areas and sealing surface areas. The frame is used as an inlet frame or as an outlet plate for a horizontal or vertical type filter unit. The support ears on the sides of the plate and frame are an integral part of the wrought plate or frame, welded to the plate or frame or attached to the plate or frame utilizing any number of fasteners. Advantageously, the filter elements may be mounted in a filter press assembly at an angle to increase drainage.

### FIELD OF THE INVENTION

The present invention relates to a wrought single piece weld-free filter element, such as an inlet frame or an outlet plate. The plate or frame is hollow in the middle and is contiguous around its perimeter. Advantageously, the filter elements may be mounted in a filter press assembly at an angle to increase drainage.

### BACKGROUND OF THE INVENTION

A horizontal-type filter press is known, for example, from U.S. Pat. No. 4,737,285 to Krulitsch et al, herein incorporated in its entirety by reference. In this patent, a horizontal-type filter press is disclosed which includes a plurality of filter elements supported on cross beams between a head and press cover. Filter aids disposed between the filter elements are moved by the filter press closing mechanism to seal the press edges located at each of the filter elements.

Filter presses of this type are known for clarifying filtration, sterilizing filtration, or residue filtration of liquids. These types of filter presses are used in the chemical industry, pharmaceutical industry, beverage industries and other industrial applications.

In a particular type of press, filtration must take place in a sealed system. Such a filter press is disclosed in U.S. Pat. No. 5,366,627, assigned to Stavo Industries, Inc., the assignee of the present application, and herein incorporated in its entirety by reference.

In these known filter units, the filter elements have inlets and outlets which are manufactured by using a casting process, by welding individual pieces of wrought metal or casting metal into a single piece. In these known embodiments, the processes of welding and casting require the further processing of metal by adding heat to allow for the formation of the final product. The heat modifies the molecular structure of the metal of the filter elements and produces areas that are stressed and areas that contain voids.

In the use of filter elements in the pharmaceutical and other industries, it is essential that sterilization of the component parts of the filter elements be possible. Accordingly, all surfaces must be free of voids or pits that can harbour contaminants. Additionally, the stress that is induced upon the metal from the heating process may cause the inlet frame or outlet plate to become slightly warped. This can lead to excessive liquid leakage from the filter unit between the filter elements, which liquid must either be discarded or reprocessed.

Accordingly, there is a need for a filter plate and filter frame free of heat stress and casting voids, that is fully uniform in thickness.

In addition, pharmaceutical and biotech fluids are extremely valuable and filter hold-up volumes can become costly. Following completion of the production cycle, current plate and frame filter presses can require that up to 90% of the liquid remaining in the filter be reprocessed or discarded.

Accordingly, there is a need for a filter element that maximizes drainage.

### SUMMARY OF THE INVENTION

The filter plate or frame of the present invention is derived from a single solid plate of metal or alloy by any one of various means, such as cutting with a water-jet, laser, wire EDM, plasma, CNC, etc. The solid plate of the metal or alloy may be 0.5-2.0 inches thick and 36 inches square, for example. Nested plates or frames of decreasing dimensions may be formed.

Most important is that the plate or frame does not require further heating or bending to provide the finished product. The plate or frame can be of any shape, be it square, rectangular, circular, triangular, etc. in any dimension, and can be of any practical thickness. If the plate or frame requires support members on the non-liquid contact sides, they can be included as an integral part of the frame, they can be welded to the plate or frame, or they can be fastened to the plate or frame as these additions will not affect the potential sterilization of the portions of the frame which is to come in contact with processed product.

In a modified filter plate or filter frame, taking advantage of a unified single piece structure or using traditional frame forming technology, advantageous draining can be achieved by tilting a traditional square shaped outlet plate at an angle of 45° in a filter press assembly. This locates a part of the outlet plate at a lowermost location having sidewalls extending at an angle to the horizontal converging at the outlet port, aiding in drainage of filtrate through a process outlet. For uniformity the inlet frame may also be fitted in a filter press assembly at 45° to provide a need for only one set of guide bars, engaging the support ears of the plates and frames.

Accordingly, it is one object of the present invention to produce a weld free filter plate or frame in the liquid contact and sealing surface areas of a filter press assembly.

It is another object of the present invention to produce a filter plate or frame free of pits and voids normally associated with casting or welding processes.

It is another object of the present invention to produce a unitary, integral filter plate or frame cut from a solid plate of metal or alloy without the use of heat so as to provide flatness to both sides of the plate and frame and thereby minimize leakage in a filter press assembly.

It is still yet another object of the present invention to produce a filter plate or frame having integral support pins located on an interior surface of the plate or frame for use in mounting opposed screen sections in the plate or frame.

It is still yet another object of the present invention to produce a filter press assembly having an outlet plate with sidewalls converging towards an outlet port positioned at a lowermost extremity of the outlet plate for increased drainage from the outlet plates of the filter press assembly.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is a plan view of a known inlet frame or outlet plate for a filter press assembly, having been manufactured by welding together four triangular pieces and four straight pieces and subsequently attaching two laterally extending ears by welding.

FIG. 2 is a cross-sectional view taken along line 2-2 of FIG. 1.

FIG. 3 is a schematic illustration of the method of the present invention used for forming a plurality of filter elements from a plate or billet of metal or alloy by use of laser or water-jet technology, for example.

FIG. 4 is a plan view of a formed inlet frame or outlet plate produced by the method illustrated in FIG. 3, formed of a single integral piece without voids or defects and having consistent flatness side to side.

FIG. 5 is a cross-sectional view taken along line 5-5 of FIG. 4.

FIG. 6 is a perspective view of an inlet frame or outlet plate formed according to the method illustrated in FIG. 3, and including slots leading to port holes on one side of the filter element, as an exemplary illustrative embodiment, and including integral formed support projections for mounting of filtration screens inside of the filter elements.

FIG. 7 is an enlarged view of one corner of the filter element shown in FIG. 6, having a tapered slot leading to a port hole.

FIG. 8 is a cross-sectional view taken along line 8-8 of FIG. 7.

FIG. 9 is an exemplary filter element formed according to the process shown in FIG. 3, or alternatively, formed by the known method of welding as shown in FIGS. 1 and 2.

FIG. 10 is an enlarged view of one corner of the filter element shown in FIG. 9.

FIG. 11 is a perspective view of a filter press assembly with the filter elements of FIGS. 4, 6 or 9 mounted in the filter press in a “diamond-shape” configuration, tilted at an angle of 45°, as compared to traditional filter presses, so as to increase drainage through the outlet plate of the filter elements.

FIG. 12 is an alternate embodiment of a filter element for mounting in a traditional filter press and having the advantages of sidewalls of the interior surface converging to an outlet port leading to a process outlet.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

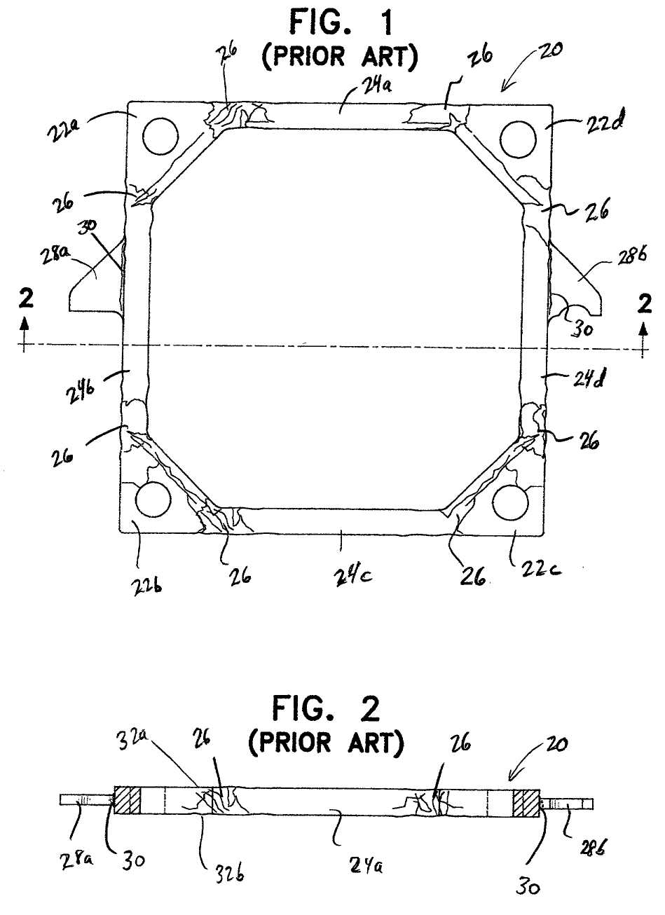

FIGS. 1 and 2 are illustrative of prior art filter elements 20 such as an inlet frame or an outlet plate which make up the alternating components between a fixed head and a movable head of a filter press assembly. Traditionally, the filter element 20 was formed by interconnecting four triangular shaped sections 22a, 22b, 22c and 22d with four bar stock sections 24a, 24b, 24c and 24d by a series of welds 26. The support ears 28a, 28b are also welded to bar sections 24b, 24d, respectively, by welds 30.

The use of filter presses in certain industries, such as the pharmaceutical industry for example, requires sterilization of component parts. As expected, a filter element as shown in FIG. 1, includes many pits and voids, particularly, at the welds 26. Therefore, to comply with the requirements of the pharmaceutical industry, extensive finishing of the frame element 20 is required.

Also, by the use of high heat welding to connect the various components, the molecular structure of the various components is altered producing warps to various degrees of deformation. This leads to a lack of overall flatness at opposed sides 32a, 32b of the filter element 20.

When a plurality of filter elements are assembled in a filter press, this lack of flatness will form gaps between the filter elements through which filtrate may leak during the filtering operation. This causes waste of product which must be discarded or reprocessed. Therefore, additional finishing of the filter element is also required to avoid this defect.

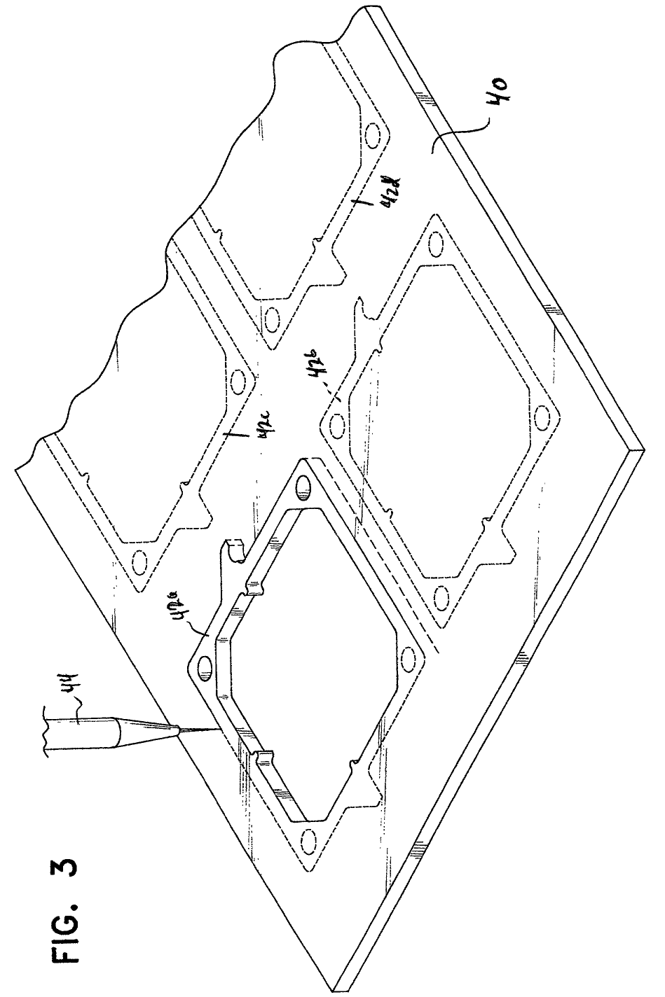

To avoid the defects exemplified by the welded filter element of FIGS. 1 and 2, it has been discovered that a flat metal or alloy plate 40 approximating the thickness of the desired end product can be used to produce a plurality of unitary filter elements 42a, 42b, 42c, 42d . . . , for example. As shown in solid lines in FIG. 3, the filter element 42a is being cut by a water-jet device 44.

The device 44 is programmed to cut along the dotted lines of FIG. 3 to form a plurality of filter elements. It is even possible to nest various sizes of filter elements one within the other to maximize usage of the plate 40.

The exemplary embodiment of water-jet cutting, does not produce heat, and thereby avoids disparities in flatness from side to side of the formed filter elements. Also, by the unitary structure of the formed filter element, no defects or voids are produced in the critical areas of the filter elements which require sterilization when used in certain industries. Therefore, with minimal finishing, the completed, unitary filter elements as formed. The filter element may be further processed to produce an inlet frame or an outlet plate as is known in the industry.

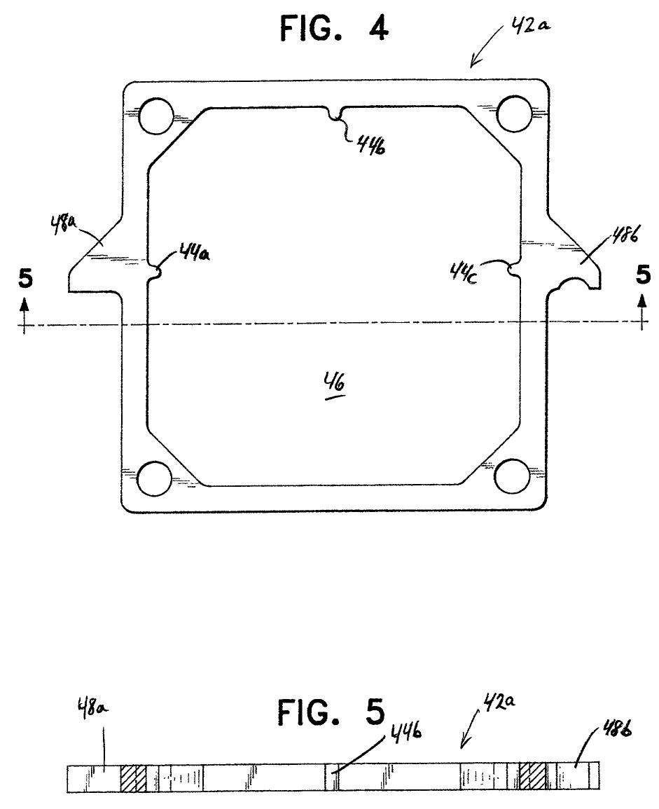

As shown in FIGS. 4 and 5, the unitary filter element may integrally include support pins 44a, 44b, 44c for use in mounting certain filter support structures in the interior 46 of the filter element 42a. Also, support ears 48a, 48b may be formed integrally with the filter element, thus avoiding another potential location to harbour potential harmful contamination.

In another exemplary filter element 50, also formed according to the process illustrated in FIG. 3, the filter element may include slots or holes 52a, 52b leading to two of the four side ports formed at the corners of the filter element 50. In this embodiment, projecting support structures 54a through 54g are formed integrally with the frame element 50.

FIGS. 7 and 8 illustrate the connection of the slot 52a to a port 56a of the four side ports 56a through 56d. Depending upon the positioning of the filter element as an inlet frame or outlet plate, in the path of the process inlet or the process outlet, liquid will flow into the interior of the inlet frame or exit from an outlet plate.

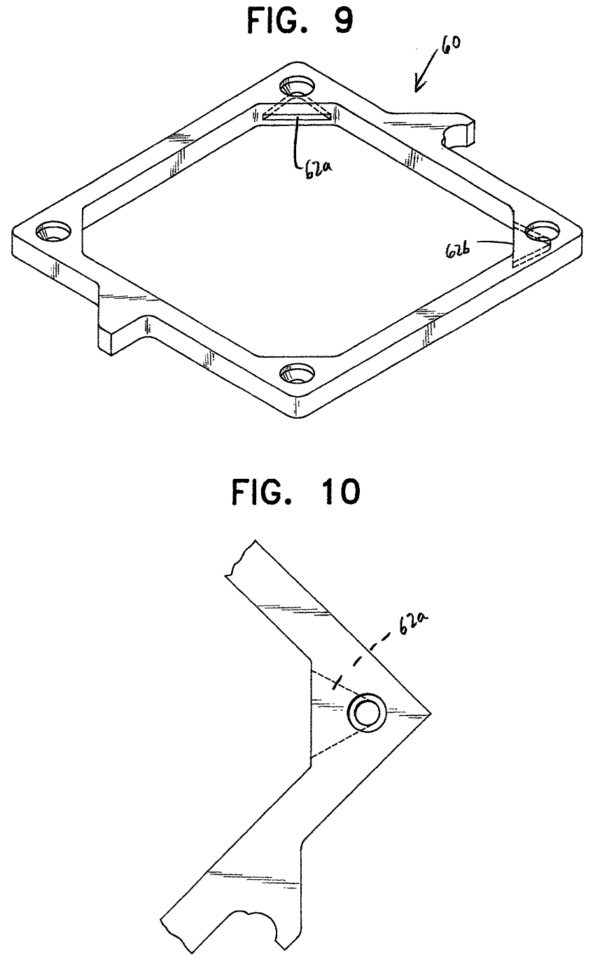

FIG. 9 is illustrative of a filter element 60 which may be formed by the method illustrated in FIG. 3 or the known method of welding to produce a filter element as shown in FIG. 1. FIG. 9 also includes slots or holes 62a, 62b which may be used to form an inlet frame or an outlet plate depending upon the positioning of the filter element 60.

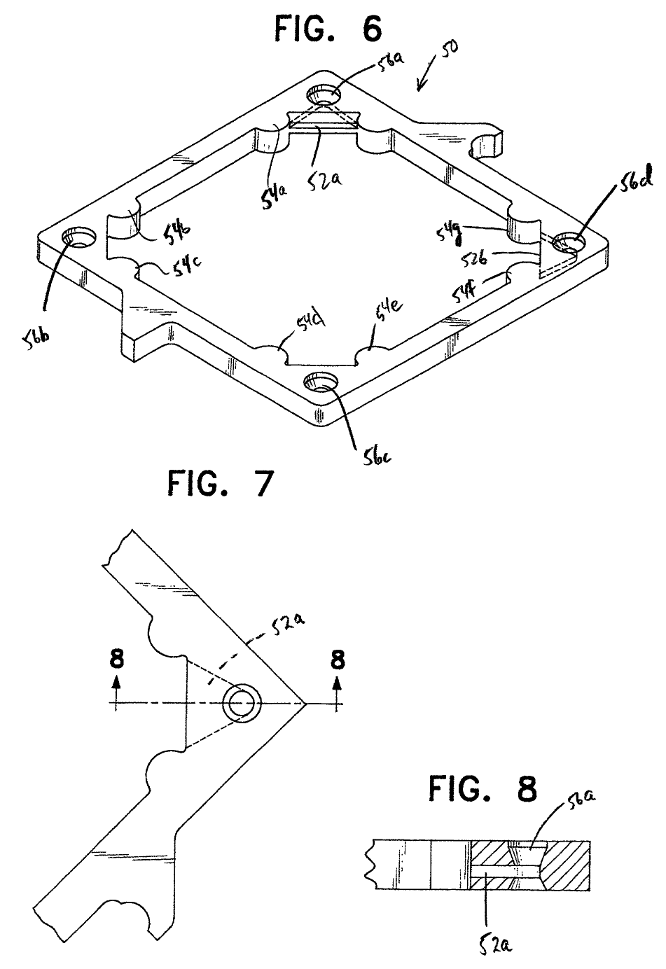

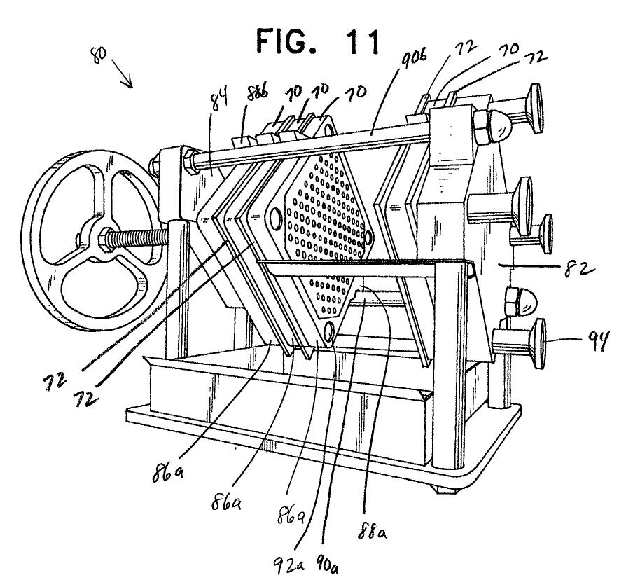

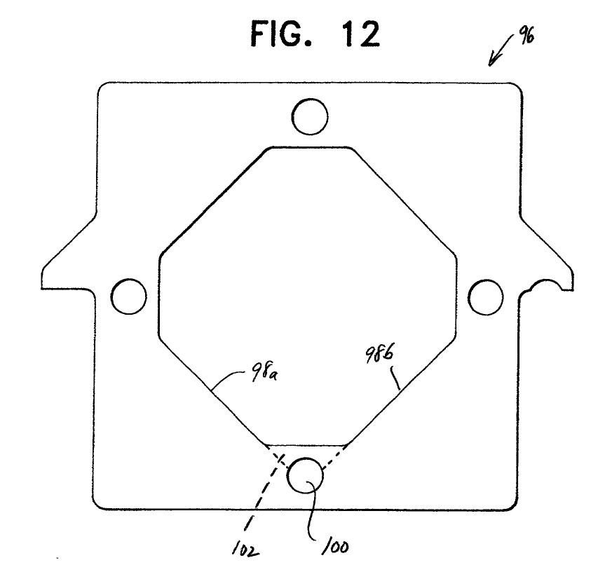

Another aspect of the present invention is the use of the filter elements 42a, 50, 60 as shown in FIGS. 4, 6 and 9, respectively, in a filter press assembly. Any of the these filter elements is schematically shown in FIG. 11 as filter elements 70 interposed between layers of filter media 72. In the filter press 80 the filter elements are mounted between a fixed head 82 and a movable head 84 to compress the filter media 72 between the filter element 70.

However, in the filter press 80 shown in FIG. 11, the filter elements are arranged, offset at an angle of 45° with respect to the arrangement of filter elements in a traditional filter press. This orientation produces a diamond shape configuration having one corner 86a positioned at a lowermost extremity of each filter element 70. This is achieved by mounting the support ears 88a, 88b, on two support rods 90a, 90b, with support rod 90a positioned lower than support rod 90b. By this arrangement, the filter element 70 arranged as an outlet plate, passes all of the residual liquid retained within the outlet plate along interior side walls converging to the process outlet port 92a of each filter element arranged as an outlet plate.

In the closed configuration of the filter press, the process outlet would thereby pass through the port 94 of the fixed head 82. Vastly improved transmission of residual liquid from the filter element is thereby achieved as compared to a traditional arrangement of the filter elements with the parallel sidewalls arranged vertically and the top and bottom surfaces arranged horizontally.

To achieve the same effect as tilted filter elements in FIG. 11, filter element 96 in FIG. 12 has interior sidewalls 98a, 98b converging towards port 100 by hole or slot 102. Port 98 is part of the process outlet of a filter press assembly.

Filter element 96 can be used in a traditional filter press assembly with parallel, equal height support bars. It may be necessary to also include adapter or transfer plates adjacent to the fixed head and moveable head to compensate for the displaced orientation of the flow through the process inlet and process outlet formed by a plurality of filter elements 96. Nevertheless, the advantages for drainage of converging sidewalls in filter elements 70 in FIG. 11, can be realized by the similarly situated converging sidewalls 98a, 98b of filter element 96 mounted in a filter press with its bottom surface oriented horizontally.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

I claim:

1. A filter press assembly comprising:
a support structure including a fixed head, a moveable head and at least one support bar extending in a direction between said fixed head and said moveable head,
a plurality of filter elements arranged on said at least one support bar to form inlet frames and outlet plates,
a process outlet from an interior of the outlet plates being arranged at a lowermost portion of the filter elements, and
side surfaces of the interior of the filter elements converging towards the process outlet at an angle to a horizontal plane.

2. A filter press assembly as claimed in claim 1, wherein there are two of said support bars and one of the two support bars is positioned above the other of the support bars.

3. A filter press assembly as claimed in claim 1, wherein the side surfaces of the interior of the outlet plates include support pins projecting into the into the interior of the outlet plates.

4. A filter press assembly as claimed in claim 1, wherein a process inlet of the inlet frames is positioned above the process outlet of the outlet plates.

5. A filter press assembly as claimed in claim 1, wherein the fixed head, the moveable head and the filter elements are arranged in a diamond shaped configuration.

6. A method of producing a filter element for a filter press assembly, said method comprising the steps of:
forming a plate of uniform thickness having parallel extending opposed upper and lower surfaces, and
cutting a filter element from the plate in the absence of generation of heat so as to maintain the uniform thickness of the cut filter element.

7. A method as claimed in claim 1, wherein a plurality of filter elements are cut from the plate.

8. A method as claimed in claim 1, wherein the filter element is cut by one of water jet, laser, wire electro-discharge machining, plasma and CDC machining.

9. A filter element for use as one of an inlet frame and an outlet plate of a filter press assembly, said filter element comprising:
a unitary, integral body having a uniform thickness devoid of surface irregularities when first formed and defining an interior opening with one port to be used as one of a process inlet and a process outlet.

10. A filter element as claimed in claim 9, wherein opposed ear supports are part of the unitary, integral body.

11. A filter element as claimed in claim 10, wherein support projections project into the interior opening and are part of the unitary, integral body.
